(19) United States
(12) Patent Application Publication
(10) Pub. No.: US 2024/0352790 A1
(43) Pub. Date: Oct. 24, 2024

(54) MANUAL AUTOMATIC INTEGRATED SUNSHADE PANEL

(71) Applicant: QINGYUAN LEYOU HOUSEHOLD ARTICLES CO., LTD, Qingyuan (CN)

(72) Inventors: Xiong Tao Pu, Qingyuan (CN); Rui Jie Pu, Qingyuan (CN); Shao Tao Pu, Qingyuan (CN)

(21) Appl. No.: 18/763,698

(22) Filed: Jul. 3, 2024

Related U.S. Application Data
(63) Continuation of application No. PCT/CN2022/103503, filed on Jul. 2, 2022.

(30) Foreign Application Priority Data
Jan. 6, 2022 (CN) 202220044381.3

(51) Int. Cl. E06B 9/72; E06B 9/44; E06B 9/50; E06B 9/62; E06B 9/68

(52) U.S. Cl. CPC E06B 9/72; E06B 9/44; E06B 9/50; E06B 9/62; E06B 9/68; E06B 2009/6818

(57) ABSTRACT

A manual automatic integrated sunshade panel is provided, the sunshade panel includes a motor, a power storage mechanism, a reel, a curtain connected with the reel, a main control module, and a sensor for recording a rotation stroke of a rotation shaft of the motor, the motor and the sensor are electrically connected with the main control module respectively; a casing or a core body of the power storage mechanism and the motor and are respectively drivingly connected with the reel, or the core body of the power storage mechanism is drivingly connected with the reel and the rotation shaft of the motor is drivingly connected with the core body of the power storage mechanism, and a casing of the motor and the casing of the power storage mechanism maintain relatively stationary. The motor can accurately control the stroke when automatically rolling up and unrolling the curtain.

### CROSS REFERENCE TO RELATED APPLICATIONS

The present application is a Continuation Application of PCT Application No. PCT/CN2022/103503 filed on Jul. 2, 2022, which claims the benefit of Chinese Patent Application No. 202220044381.3 filed on Jan. 6, 2022. All the above are hereby incorporated by reference in their entirety.

### FIELD

The subject matter herein generally relates to a field of sunshade devices, and particularly to a manual automatic integrated sunshade panel.

### BACKGROUND

A patent application with an application number of CN201920754592.4 discloses an electric roller shutter device with a power storage device, the electric roller shutter device includes an power storage component, a motor, a rolling shaft, a curtain surface, and a fixing shaft, the power storage component includes a torsion spring, a fixing rod, and a connection bracket, the torsion spring is fixedly engaged in the connection bracket, the fixing rod is passed through the connection bracket and the torsion spring and is fixedly connected with the fixing shaft, a connection rod is provided on the connection bracket, the connection rod is fixedly connected with the rolling shaft, a rotor on the motor is fixedly connected with the rolling shaft, one end of the curtain surface is fixedly connected with the rolling shaft, when the curtain surface is descended, the power storage component stores power, and when the curtain surface is raised, the power storage component provides an upward elastic force to the curtain surface, so that in the process of the curtain surface being pulled up and down, the downward weight of the curtain surface and the upward elastic force of the power storage component always maintain force-balance, the motor is controlled by a forward and reverse power supply mode, to destroy an elastic force balance state of the curtain and, so that the curtain can be raised and lowered manually and electrically to adjust a lighting function of the curtain.

A patent application with an application number of CN201920968282.2 discloses a roller shutter drive device, the roller shutter drive device includes a driver arranged in a reel, a shaft inserted into the reel, and a transmission mechanism, the driver includes a casing fixed relative to the reel, a rotating power member arranged in the casing, a driving gear fixed on an output shaft of the rotating power member and coaxial with an output end, and a first transmission gear pivotally arranged on the casing and meshing with the driving gear, the roller shutter drive device is provided with at least two drivers linearly connected in sequence, a driving gear of a driver adjacent to the transmission mechanism is connected with the transmission mechanism in a transmission cooperation manner, and the driving gears of the remaining drivers are all engaged with the first transmission gear of the driver adjacent to the transmission mechanism.

The above solutions have same problem that if a person manually pulls the curtain to raise or lower for a certain distance, at this time, the number of turns of the motor is unknown if the curtain is required to be fully rolled up or fully unrolled.

The problem to be solved by the present disclosure is that how to ensure that the motor can rotate accurately during automatic rolling up and unrolling of the curtain after manual intervention, to avoid damage to the motor and achieve a purpose of complete rolling up and unrolling.

### SUMMARY

A purpose of the present disclosure is to provide a manual automatic integrated sunshade panel, the sunshade panel utilizes a sensor to record a rotation stroke of the shaft of the motor, so that the stroke of the curtain can be determined when the user pulls the curtain, and the motor can accurately control the stroke when automatically rolling up and unrolling the curtain, thereby achieving complete rolling up and unrolling, and fully protecting the motor.

In order to realize the purpose, a manual automatic integrated sunshade panel is provided, the sunshade panel includes a motor, a power storage mechanism, a reel, a curtain connected with the reel, a main control module, and a sensor for recording a rotation stroke of a rotation shaft of the motor, the motor and the sensor are electrically connected with the main control module respectively;
a casing or a core body of the power storage mechanism and the motor and are respectively drivingly connected with the reel, or the core body of the power storage mechanism is drivingly connected with the reel and the rotation shaft of the motor is drivingly connected with the core body of the power storage mechanism, and a casing of the motor and the casing of the power storage mechanism maintain relatively stationary.

In the above-mentioned manual automatic integrated sunshade panel, the motor and the power storage mechanism are respectively arranged at two ends of the reel, and the rotation shaft of the motor is connected with the reel through a rotation terminal coaxially arranged with the reel; the casing of the power storage mechanism is connected with the reel, and the core body of the power storage mechanism is connected with an external fixing unit.

In the above-mentioned manual automatic integrated sunshade panel, the sunshade panel further includes a rotation terminal coaxially arranged and connected with the reel, the rotation shaft of the motor and an input shaft of the core body of the power storage mechanism are connected with each other by shaft transmission, an output shaft of the core body of the power storage mechanism and a shaft of the rotation terminal are connected with each other by shaft transmission, and the casing of the motor and the casing of the power storage mechanism maintain in a relatively stationary state.

In the above-mentioned manual automatic integrated sunshade panel, the power storage mechanism includes an power storage module or more than one power storage modules connected in sequence in a detachable manner, and the input shaft and output shaft of the core body of the power storage mechanism are respectively drivingly connected with the power storage modules at both ends.

In the above-mentioned manual automatic integrated sunshade panel, the power storage mechanism further includes a first commutator and a second commutator, the input shaft is arranged in the first commutator, and the output shaft is arranged in the second commutator;

the power storage module includes a bracket, a first gear fixed in the bracket, and a coil spring shaft coaxially connected with the first gear, the coil spring shaft is provided with a coil spring for power storage; when the power storage mechanism includes a number of power storage modules, the first gears of the plurality of power storage modules are engaged in sequence;
the first commutator and the second commutator are respectively engaged with the first gear of the corresponding power storage module.

In the above-mentioned manual automatic integrated sunshade panel, the first commutator and the second commutator are both gear commutators, and a commutation angle of the first commutator and the second commutator is 90°.

In the above-mentioned manual automatic integrated sunshade panel, a number of ridge members that are drivingly connected with the reel are provided on outer periphery of the rotation terminal.

In the above-mentioned manual automatic integrated sunshade panel, an inner cylinder is provided in the reel, and the motor is fixed on the inner cylinder; the inner cylinder is connected with an external fixing unit.

In the above-mentioned manual automatic integrated sunshade panel, both ends of the reel are connected with an external fixing unit via a bearing.

In the above-mentioned manual automatic integrated sunshade panel, the sunshade panel further includes a counterweight rod connected with a free side of the curtain.

Compared with the prior art, the beneficial effects of the present disclosure include that:
the sunshade panel utilizes a sensor to record a rotation stroke of the shaft of the motor, so that the stroke of the curtain can be determined when the user pulls the curtain, and the motor can accurately control the stroke when automatically rolling up and unrolling the curtain, thereby achieving complete rolling up and unrolling, and fully protecting the motor.

### BRIEF DESCRIPTION OF THE DRAWINGS

FIG. 1 is a solid view of an embodiment 1 according to the present disclosure;

FIG. 2 is a left view of the embodiment 1 according to the present disclosure;

FIG. 3 is a A-A section view of FIG. 2 of the embodiment 1 according to the present disclosure;

FIG. 4 is a solid view of a power storage mechanism of the embodiment 1 according to the present disclosure;

FIG. 5 is a left view of an embodiment 2 according to the present disclosure;

FIG. 6 is a B-B section view of FIG. 5 of the embodiment 2 according to the present disclosure;

FIG. 7 is a front view of cooperation between a power storage mechanism between a rotation terminal of the embodiment 2 according to the present disclosure;

FIG. 8 is a solid view of the cooperation between the power storage mechanism between the rotation terminal of the embodiment 2 according to the present disclosure.

### DETAILED DESCRIPTION

The following is combined with the drawings in the embodiments of the present disclosure to clearly and completely describe the technical solutions in the embodiments of the present disclosure, obviously, the described embodiments are only part of the embodiments of the present disclosure, not all of the embodiments. Based on the embodiments of the present disclosure, all other embodiments obtained by the persons skilled in the art without creative work are within the scope of protection of the present disclosure.

### Embodiment 1

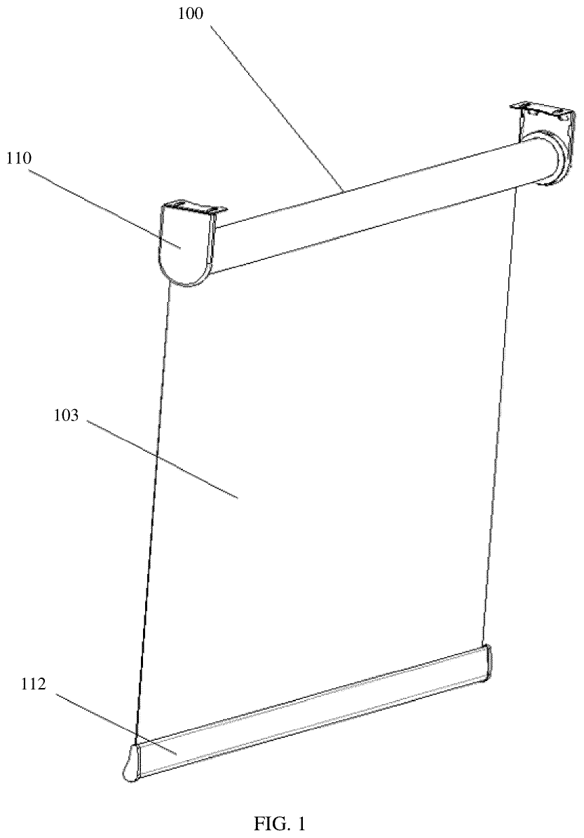

Referring to FIGS. 1 to 4, a manual automatic integrated sunshade panel includes a motor 100, an power storage mechanism 101, a reel 102, and a curtain 103 connected with the reel 102; and further includes a main control module 104 and a sensor 105, the sensor 105 is used to record rotation stroke of a rotation shaft 113 of the motor 100, the motor 100 and the sensor 105 are electrically connected with the main control module 104 respectively;

The motor 100 and a casing 106 or a core body of power storage mechanism 101 are respectively drivingly connected with the reel 102, that is, the motor 100 and a casing 106 or a core body of power storage mechanism 101 are respectively connected with the reel 102 in a transmission manner.

A first practical alternative is shown below: the casing 106 of the power storage mechanism 101 and the reel 102 are drivingly connected.

The sunshade panel in some embodiments has two states including manual and automatic, and is equipped with a remote controller, the remote controller is communicated with the main control module 104, the sunshade panel in some embodiments further includes power supply or is electrically connected with power supply of an external device; the power supply is electrically connected with the main control module 104;

The main control module 104 is provided with a single chip microcomputer or a controller, the main control module 104 is used to control the motor 100.

The sensor 105 in some embodiments is a Hall sensor, the sensor 105 is preferably fixed on a circuit board of the main control module 104; therefore, a power output shaft of the motor 100 in some embodiments is passed through both ends of a main body of the motor 100.

In the manual state, the motor 100 is not in operation, the motor 100 can rotate freely, when the curtain 103 is manually pulled, the power storage mechanism 101 starts to store power, and the reel 102 drives the rotation shaft 113 of the motor 100 to rotate, at this time, the sensor 105 calculates the rotation stroke of the rotation shaft of the motor 100;

If the remote controller transmits a rolling up or unrolling signal to the main control module 104 under the control from a user, the motor 100 calculates a number of turns or a rotation angle of the motor 100 when the curtain reaches a fully rolling up or unrolling state based on the rotation stroke.

In some embodiments, the power output of the motor 100 is not the main driving force for the rotation of the reel 102, but is used to destroy a power storage balance state of the power storage mechanism 101, therefore, the motor 100 have a large output power in an initial startup stage, and does not generate the large output power during the continuous rolling up and unrolling process.

In detail, the motor 100 and the power storage mechanism 101 are respectively arranged at the two ends of the reel 102, and the rotation shaft of the motor 100 is drivingly connected with the reel 102 via a rotation terminal 114 coaxially arranged with the reel 102; the casing 106 of the power storage mechanism 101 is connected with the reel 102, and the core body of the power storage mechanism 101 is connected with an external fixing unit.

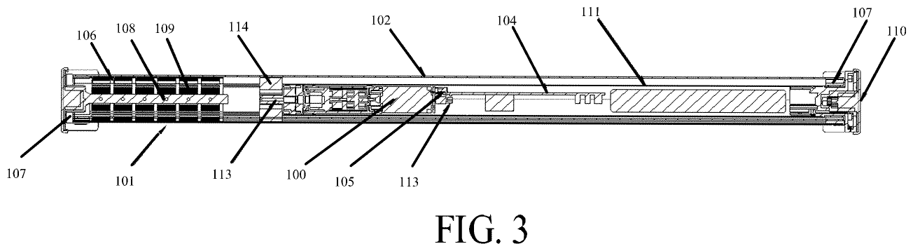

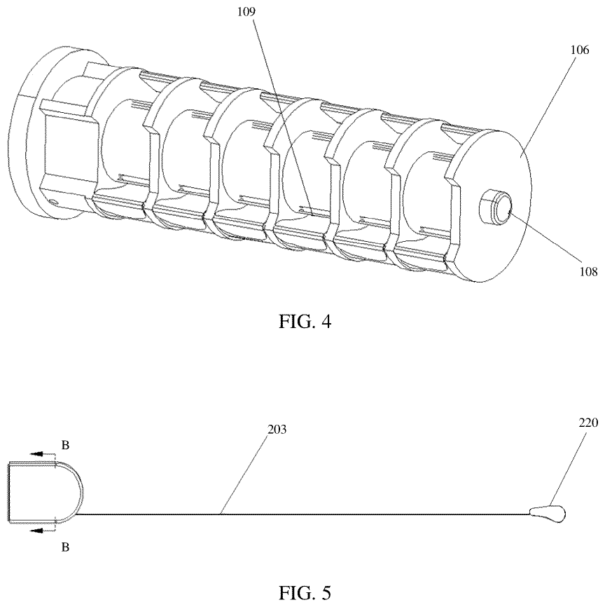

Referring to FIGS. 3 and 4, the power storage mechanism 101 includes a casing 106 and a core body, the core body includes an axis 108 and a coil spring 109 wound around the axis 108, a free end of the coil spring 109 is connected with the casing 106, and the axis 108 is connected with the external fixing unit, the external fixing unit may be a connection plate 110 connected with a wall surface, or may be directly a wall surface; in this specific scenario, the casing 106 is rotatable, and the core body is stationary.

In some embodiments, the power storage mechanism 101 can also be selected as the driver described in the patent application with an application number of CN201920968282.2; the power storage mechanism 101 can also be selected as the power storage assembly shown in the patent application with an application number of CN201920754592.4. These are representative cases that the casing 106 is rotatable but the core body is stationary.

In some embodiments, a first inner cylinder 111 is provided in the reel 102, and the motor 100 is fixed on the first inner cylinder 111; the first inner cylinder 111 is connected with an external fixing unit; that is, the first inner cylinder 111 is stationary and the reel 102 is rotatable.

In some embodiments, outer periphery of the rotation terminal 114 is provided with a number of ridge members for transmission connection with the reel 102 of the curtain, correspondingly, a groove corresponding to the ridge members are provided in an inner wall of the reel 102, so that the rotation terminal and the reel 102 maintain a radially relative stationary state.

A second practical alternative is shown below: in other embodiments, the core body of the power storage mechanism 101 is drivingly connected with the reel 102;

In such case, the casing 106 of the power storage mechanism 101 is fixed, the power storage mechanism 101 further includes a second inner cylinder, and the second inner cylinder is fixedly connected with the external fixing unit, that is, the second inner cylinder is stationary, and the reel 102 is rotatable;

At this time, the end of the core body is connected with the reel 102 through another rotation terminal.

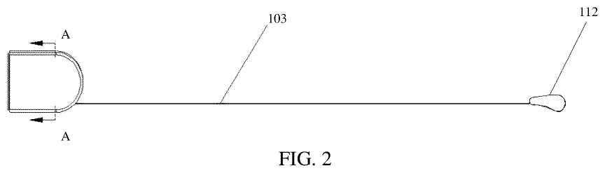

To implement this solution, it is only necessary to make corresponding adjustments to the power storage mechanism 101 in FIG. 2, that is, the casing 106 is fixed in the second inner cylinder, and the core body is connected with the reel 102 via a rotation terminal.

In some embodiments, both ends of the reel 102 are connected with the external fixing unit via an inner bearing 107 or an outer bearing.

In some embodiments, the sunshade panel further includes a counterweight rod 112, the counterweight rod 112 is connected with a free side of the curtain 103, and the other side of the curtain 103 is connected with the reel 102. The weight of the counterweight rod 112 is selected within a limit of the power storage mechanism 101.

### Embodiment 2

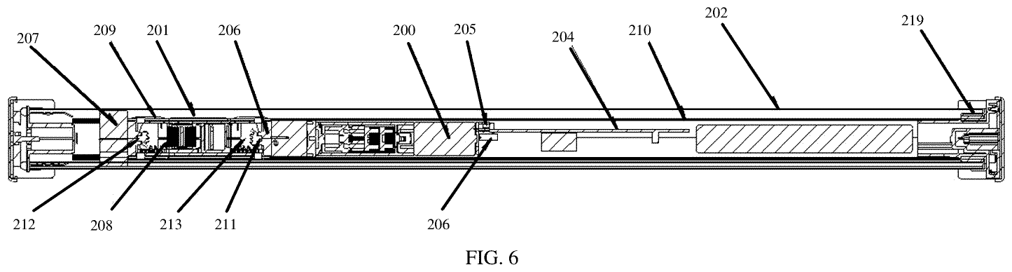

Referring to FIGS. 5 to 8, a manual automatic integrated sunshade panel includes a motor 200, an power storage mechanism 201, a reel 202, and a curtain 203 connected with the reel 202; and the sunshade panel further includes a main control module 204 and a sensor 205 for recording the rotation stroke of a rotation shaft 206 of the motor 200, the motor 200 and the sensor 205 are electrically connected with the main control module 204 respectively;

The core body 208 of the power storage mechanism 201 is drivingly connected with the reel 202, the rotation shaft 206 of the motor 200 is drivingly connected with the core body 208 of the power storage mechanism 201, and the casing 209 of the power storage mechanism 201 and the casing of the motor 200 maintain in a relatively stationary state, that is, the casing of the motor 200 and the casing 209 of the power storage mechanism 201 are fixedly connected by a connection rod or other means.

The operation process and control principle of the sunshade panel are the same as those of Embodiment 1, which are not repeated.

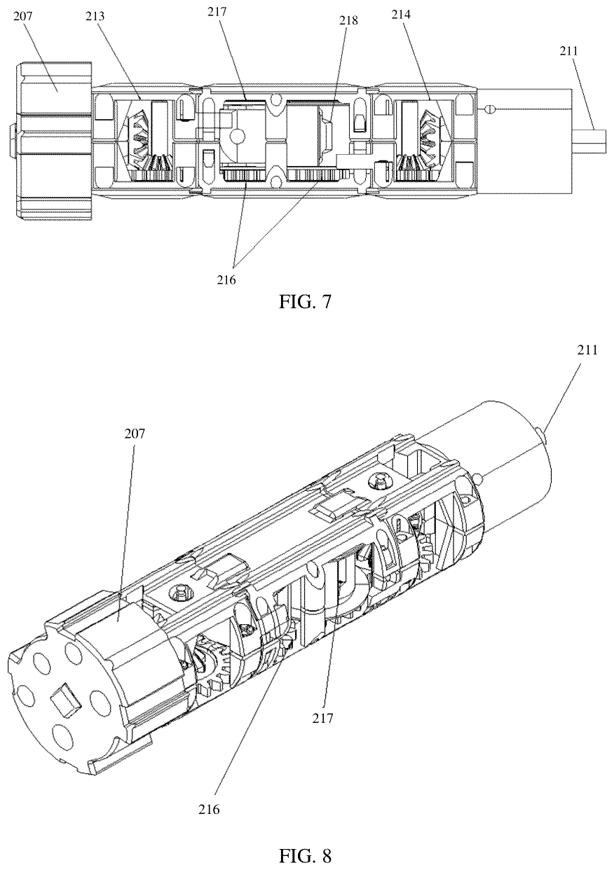

Referring to FIGS. 7 and 8, a power storage mechanism 201 in some embodiments is shown, the power storage mechanism 201 includes a rotation terminal 207 coaxially arranged and connected with the reel 202, the rotation shaft 206 of the motor 200 and the input shaft 211 of the core body 208 of the power storage mechanism 201 are connected with each other by shaft transmission, the output shaft 212 of the core body 208 of the power storage mechanism 201 and the shaft of the rotation terminal 207 are connected with each other by shaft transmission, the casing of the motor 200 and the casing 209 of the power storage mechanism 201 maintain in a relatively stationary state.

As another embodiment, a first inner cylinder 210 can be provided inside the reel 202, the motor 200 and the power storage mechanism 201 can be fixed inside the first inner cylinder 210.

In some embodiments, the power storage mechanism 201 includes one power storage module or more than one power storage modules connected in a detachable manner in sequence, the input shaft 211 and the output shaft 212 of the core body 208 of the power storage mechanism 201 are respectively drivingly connected with the power storage modules at both ends. The power storage mechanism 201 further includes a first commutator 213 and a second commutator 214, the input shaft 211 is arranged in the first commutator 213, and the output shaft 212 is arranged in the second commutator 214; the power storage module includes a bracket 215, a first gear 216 fixed in the bracket 215, and a coil spring shaft 217 coaxially connected with the first gear 216, a coil spring 218 for power storage is provided on the coil spring shaft 217; if there are a number of power storage modules, the first gears 216 of the number of power storage modules are engaged in sequence; the first commutator 213 and the second commutator 214 are respectively engaged with the first gear 216 of the corresponding power storage module.

In some embodiments, the shaft of the first gear 216 is perpendicular to the shaft of the reel 202, the commutation angles of the first commutator 213 and the second commutator 214 are 90°.

The transmission method of the sunshade panel includes that: the rotation shaft 206 of the motor 200 outputs a slight power, to drive the input shaft 211 on the first commutator 213, the first commutator 213 drives the first gear 216, the first gear 216 transmits power to drive the second commutator 214, and the output shaft 212 of the second commutator 214 drives the rotation terminal 207 to rotate.

As another specific power storage mechanism 201, the power storage mechanism 201 in FIG. 2 may be used. The casing 209 of the power storage mechanism 201 in FIG. 2 is fixed on the first inner cylinder 210, and the core body 208 is connected with the rotation shaft 206 and the rotation terminal 207 of the motor 200.

By applying a similar principle, the power storage mechanism 201 can be selected as the driver described in the patent application with an application number of CN201920968282.2; the power storage mechanism 201 can also be selected as the power storage assembly described in the patent application with an application number of CN201920754592.4; the power storage mechanism 201 can also be selected as the torsion spring described in the patent application with an application number of CN201080007138.4 can also be selected; in this process, adaptive modifications can be made according to the method specified in this embodiment in which the casing 209 is stationary and the core body 208 is rotatable.

In this embodiment, the bearing 219 and the counterweight rod 220 are the same as those in Embodiment 1, which is not described.

What is claimed is:

1. A manual automatic integrated sunshade panel, comprising a motor, a power storage mechanism, a reel, a curtain connected with the reel, a main control module, and a sensor for recording a rotation stroke of a rotation shaft of the motor, wherein the motor and the sensor are electrically connected with the main control module respectively;
wherein a casing or a core body of the power storage mechanism and the motor and are respectively drivingly connected with the reel, or the core body of the power storage mechanism is drivingly connected with the reel and the rotation shaft of the motor is drivingly connected with the core body of the power storage mechanism, and a casing of the motor and the casing of the power storage mechanism maintain relatively stationary.

2. The manual automatic integrated sunshade panel according to claim 1, wherein the motor and the power storage mechanism are respectively arranged at two ends of the reel, and the rotation shaft of the motor is connected with the reel through a rotation terminal coaxially arranged with the reel;
the casing of the power storage mechanism is connected with the reel, and the core body of the power storage mechanism is connected with an external fixing unit.

3. The manual automatic integrated sunshade panel according to claim 1, further comprising a rotation terminal coaxially arranged and connected with the reel, the rotation shaft of the motor and an input shaft of the core body of the power storage mechanism are connected with each other by shaft transmission, an output shaft of the core body of the power storage mechanism and a shaft of the rotation terminal are connected with each other by shaft transmission, and the casing of the motor and the casing of the power storage mechanism maintain in a relatively stationary state.

4. The manual automatic integrated sunshade panel according to claim 3, wherein the power storage mechanism comprises a power storage module or more than one power storage modules connected in sequence in a detachable manner, and the input shaft and output shaft of the core body of the power storage mechanism are respectively drivingly connected with the power storage modules at both ends.

5. The manual automatic integrated sunshade panel according to claim 4, wherein the power storage mechanism further comprises a first commutator and a second commutator, the input shaft is arranged in the first commutator, and the output shaft is arranged in the second commutator;
wherein the power storage module comprises a bracket, a first gear fixed in the bracket, and a coil spring shaft coaxially connected with the first gear, the coil spring shaft is provided with a coil spring for power storage; when the power storage mechanism comprises a plurality of power storage modules, the first gears of the plurality of power storage modules are engaged in sequence;
wherein the first commutator and the second commutator are respectively engaged with the first gear of the corresponding power storage module.

6. The manual automatic integrated sunshade panel according to claim 5, wherein the first commutator and the second commutator are both gear commutators, and a commutation angle of the first commutator and the second commutator is 90°.

7. The manual automatic integrated sunshade panel according to claim 2, wherein a plurality of ridge members that are drivingly connected with the reel are provided on outer periphery of the rotation terminal.

8. The manual automatic integrated sunshade panel according to claim 3, wherein a plurality of ridge members that are drivingly connected with the reel are provided on outer periphery of the rotation terminal.

9. The manual automatic integrated sunshade panel according to claim 1, wherein an inner cylinder is provided in the reel, and the motor is fixed on the inner cylinder; the inner cylinder is connected with an external fixing unit.

10. The manual automatic integrated sunshade panel according to claim 2, wherein an inner cylinder is provided in the reel, and the motor is fixed on the inner cylinder; the inner cylinder is connected with an external fixing unit.

11. The manual automatic integrated sunshade panel according to claim 3, wherein an inner cylinder is provided in the reel, and the motor is fixed on the inner cylinder; the inner cylinder is connected with an external fixing unit.

12. The manual automatic integrated sunshade panel according to claim 4, wherein an inner cylinder is provided in the reel, and the motor is fixed on the inner cylinder; the inner cylinder is connected with an external fixing unit.

13. The manual automatic integrated sunshade panel according to claim 5, wherein an inner cylinder is provided in the reel, and the motor is fixed on the inner cylinder; the inner cylinder is connected with an external fixing unit.

14. The manual automatic integrated sunshade panel according to claim 6, wherein an inner cylinder is provided in the reel, and the motor is fixed on the inner cylinder; the inner cylinder is connected with an external fixing unit.

15. The manual automatic integrated sunshade panel according to claim 1, wherein both ends of the reel are connected with an external fixing unit via a bearing.

16. The manual automatic integrated sunshade panel according to claim 2, wherein both ends of the reel are connected with an external fixing unit via a bearing.

17. The manual automatic integrated sunshade panel according to claim 3, wherein both ends of the reel are connected with an external fixing unit via a bearing.

18. The manual automatic integrated sunshade panel according to claim 4, wherein both ends of the reel are connected with an external fixing unit via a bearing.

19. The manual automatic integrated sunshade panel according to claim 5, wherein both ends of the reel are connected with an external fixing unit via a bearing.

20. The manual automatic integrated sunshade panel according to claim 1, further comprising a counterweight rod connected with a free side of the curtain.
